(19) United States
(12) Patent Application Publication
(10) Pub. No.: US 2017/0043884 A1
(43) Pub. Date: Feb. 16, 2017

(54) METHODS AND SYSTEMS FOR HEALTH MANAGEMENT OF A FLEET OF AIRCRAFT

(71) Applicant: Airbus (S.A.S.), Blagnac Cedex (FR)

(72) Inventors: François BEDIN, SAINT LYS (FR); Pascal EYMERY, BALMA (FR)

(21) Appl. No.: 14/825,852

(22) Filed: Aug. 13, 2015

(51) Int. Cl. B64F 5/00; G07C 5/08; G07C 5/00

(52) U.S. Cl. CPC B64F 5/0045; G07C 5/008; G07C 5/085; G07C 5/006

(57) ABSTRACT

A health management system providing services for managing a fleet of aircraft. In some examples, the system includes one or more computers and one or more non-transitory computer readable media storing instructions that, when executed by the one or more computers, cause the one or more computers to provide the health management services. In operation, the system creates, for each aircraft of the fleet of aircraft, a record specifying an initial configuration of the aircraft as of a delivery date of the aircraft. The system stores, with each record for each aircraft, a history of one or more actions altering the initial configuration of the aircraft. The system produces, in response to a request concerning one of the aircraft, a report specifying a current configuration for the aircraft based on the initial configuration of the aircraft and the history of actions altering the initial configuration of the aircraft.

### TECHNICAL FIELD

The subject matter disclosed herein relates generally to management of a fleet of aircraft, e.g., to a system for health management of a fleet of aircraft.

### BACKGROUND

Maintenance of an aircraft fleet is crucial for the safety and reliability of airline operations. For efficient maintenance of the aircraft fleet, an airline needs to manage multiple maintenance service suppliers and spare part suppliers in an efficient and coordinated manner. Spare part suppliers can get spare parts from original equipment manufacturers (OEM) or part manufacturer's approval suppliers (PMA). Maintenance, repair and overhaul (MRO) organizations perform maintenance and repair activities to guarantee a reliable operation of the aircraft. Airlines which are typically customers of maintenance services can also provide maintenance services to other airlines.

As the maintenance tasks and the configuration follow-up on an aircraft can be completed by various entities, e.g., people/organization/airlines, using various different tools, the associated cost to ensure a global traceability for an airline or a leaser are more and more difficult to support.

### SUMMARY

A health management system provides services for managing a fleet of aircraft. The system can provide the services to ensure an end to end follow-up from a first entity, e.g., a production entity, to a second entity, e.g., the operator, of all events linked to the configuration and maintenance operations. The services can ensure a traceability of the maintenance operation all along the life of the aircraft independently of the operator. The services can be provided by a cloud computing system, e.g., on the Internet, and the services can ensure a high level of availability and integrity of the data. The cloud computing system can store, with each record for each aircraft, a history of one or more actions altering the initial configuration of the aircraft and associated context data such as the logbook entry events, the maintenance task card. The service can, in some examples, provide for all actors (e.g., maintenance, overhaul and repair; airlines; authority), in response to an authorized request concerning one of the aircraft, a report specifying the history and the current status of the configuration for the aircraft based on the configuration of the aircraft and the history of actions altering the initial configuration of the aircraft.

In some examples, the system includes one or more computers and one or more non-transitory computer readable media storing instructions that, when executed by the one or more computers, cause the one or more computers to provide the health management services. In operation, the system creates, for each aircraft of the fleet of aircraft, a record specifying an initial configuration of the aircraft as of a delivery date of the aircraft. The systems stores, with each record for each aircraft, a history of one or more actions altering the initial configuration of the aircraft. The system produces, in response to a request concerning one of the aircraft, a report specifying a current configuration for the aircraft based on the initial configuration of the aircraft and the history of actions altering the initial configuration of the aircraft.

The subject matter described in this specification may be implemented in hardware, software, firmware, or any combination thereof. As such, the terms “function”, “node” or “module” as used herein refer to hardware, software and/or firmware components for implementing the feature(s) being described. In some examples, the subject matter described in this specification may be implemented using a non-transitory computer readable medium storing computer executable instructions that when executed by the processor of a computer cause the computer to perform steps.

Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms

### BRIEF DESCRIPTION OF THE DRAWINGS

FIG. 1 is a block diagram of an example computing environment for an example fleet of aircraft;

FIG. 2A is a block diagram of an example health management system;

FIG. 2B is an example screen of an example user interface;

FIG. 2C is a block diagram of an example configuration checker;

FIG. 3 is a block diagram of an example health platform database; and

FIG. 4 is a flow diagram of an example method for health management of a fleet of aircraft.

### DETAILED DESCRIPTION

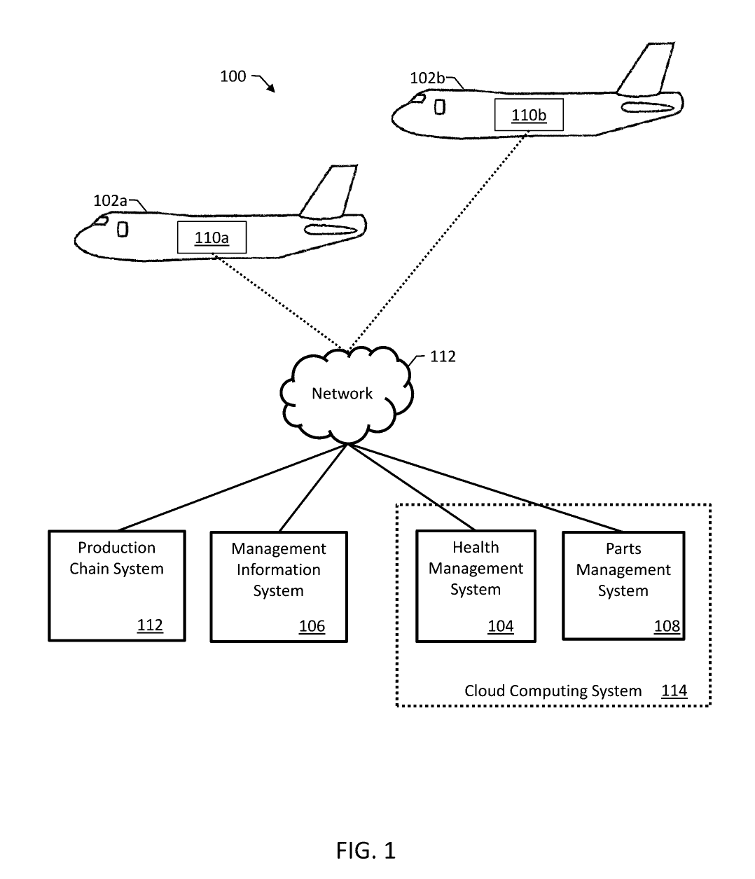

FIG. 1 is a block diagram of an example computing environment generally designated 100 for an example fleet of aircraft 102a and 102b. The environment 100 includes a health management system 104 of one or more computers configured, by virtue of appropriate programming, to provide health management services for the fleet of aircraft 102a-b.

The health management system 104 collects data from various other optional computing systems, e.g., an airline or maintenance, repair and overhaul (MRO) management information system (MIS) 106, a parts management system 108, a production chain system such 112 as an Airframer production chain system, and on-board computer systems 110a and 110b on the aircrafts 102a and 102b, respectively. The health management system 104 communicates with the other systems using a data communications network 112. The data communications network 112 includes, e.g., corporate local area networks (LANs), the Internet, and/or one or more wireless networks for communicating with the on-board computing systems 110a-b. In some examples, the health management system 104 and/or the parts management system 108 can be implemented on a cloud computing system 114 and configured to provide various services as cloud computing services. The health management system 104 can communicate through the cloud by an aircraft data communications network.

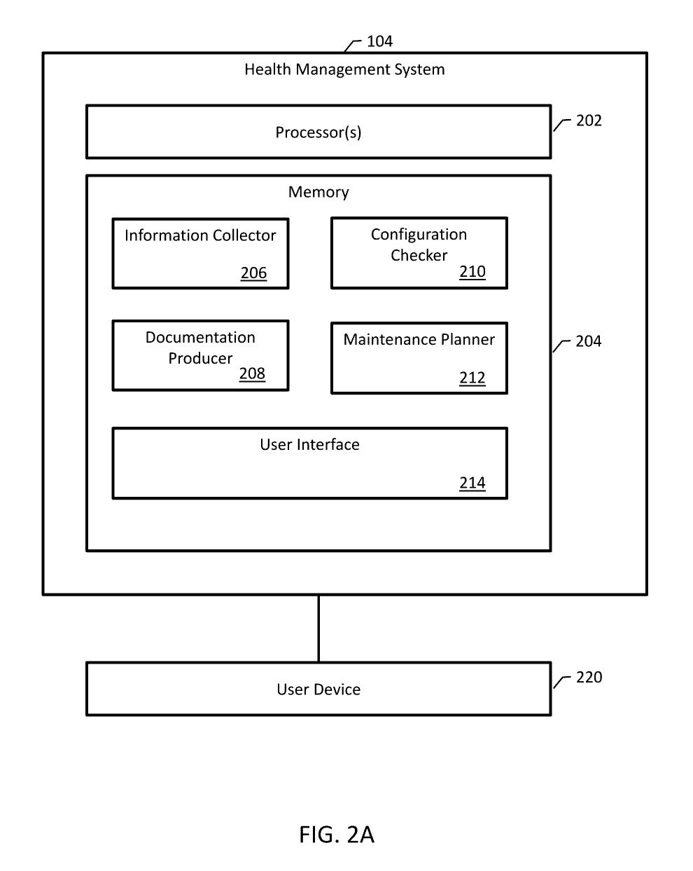

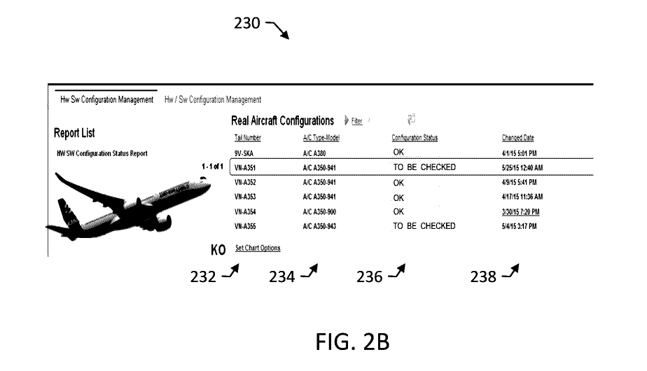

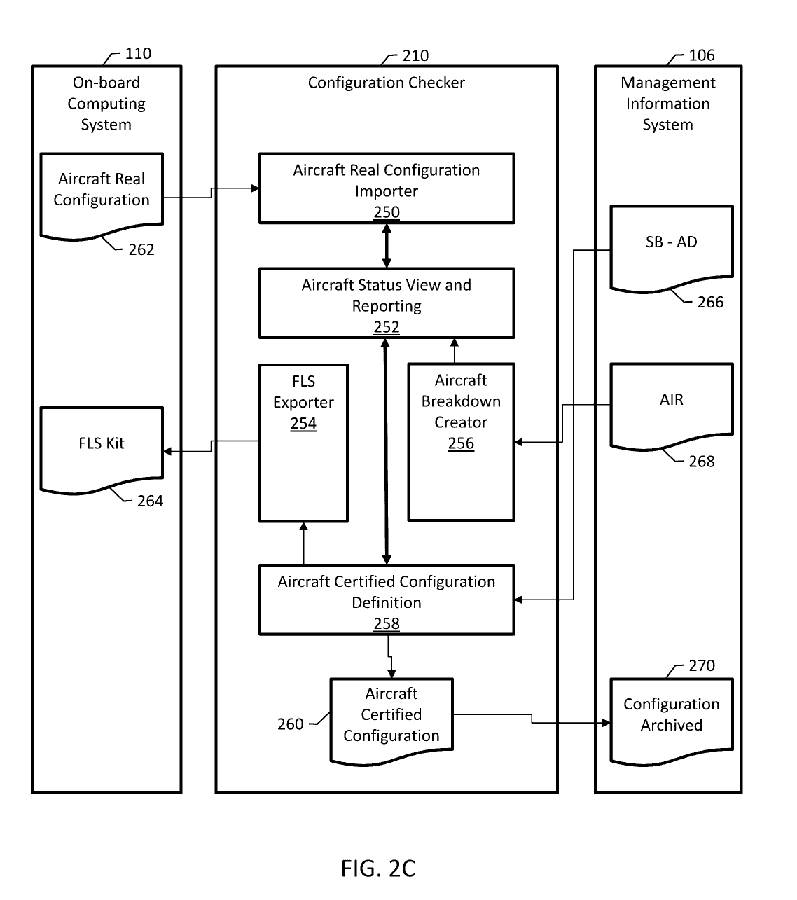

In operation, the health management system 104 creates, for each aircraft of the fleet of aircraft 102a-b, one or more records specifying an initial configuration of the aircraft as of a delivery date of the aircraft and maintenance task status and logbook events. The health management system 104 can be initialized by the production chain system 112. The health management system 104 stores, with each record for each aircraft, a history of one or more actions altering the initial configuration of the aircraft. The health management system 104 produces, in response to a request concerning one of the aircraft, a report specifying a current configuration for the aircraft based on the initial configuration of the aircraft and the history of actions altering the initial configuration of the aircraft. The health management system 104 is described in further detail below with reference to FIG. 2.

The management information system 106 includes a system of one or more computers configured, by virtue of appropriate programming, to provide information technology (IT) and/or information services (IS) for one or more airlines. The management information system 106 executes enterprise software applications, e.g., for resource and people management, project management, decision support, and database management. The management information system 106 includes a management information database storing information related to the fleet of aircraft 102a-b.

The parts management system 108 includes a system of one or more computers configured, by virtue of appropriate programming, to provide information characterizing parts for the fleet of aircraft 102a-b. For example, the parts management system 108 includes, or interface with, a computer system of an original equipment manufacturer (OEM) and/or a computer system of a maintenance, repair, and overhaul organization (MRO). In some examples, the parts management system 108 maintains an inventory of spare parts, tools, and other materials for providing maintenance services for the fleet of aircraft 102a-b. The inventory specifies the locations of the parts, tools, and materials.

The on-board computer systems 110a-b includes any appropriate on-board device that supply data for the health management system 104 to collect, e.g., aircraft condition monitoring systems (ACMSs). The on-board computer systems 110a-b provide data to the health management system 104, e.g., over a wireless communications link while the aircraft on the ground.

An aircraft condition monitoring system is typically a computer system configured, by virtue of appropriate programming, to provide flight performance data for an aircraft to monitor aircraft engine performance. The aircraft condition monitoring system records flight performance data from a variety of sources, e.g., sensors and other data producing devices on-board the aircraft. In some examples, the aircraft condition monitoring system transmits the flight performance data to an aircraft communication and reporting system (AGARS). The aircraft communication and reporting system are configured to provide real-time or near real-time transmission of some or all of the flight performance data to the ground, where the health management system 104 collects the flight performance data.

One fleet of aircraft 102a-b is illustrated in FIG. 1. The health management system 104 is configured to provide health management services for one or more fleets of aircraft. For example, the health management system 104 maintains separate accounts for one or more airlines, and users from the airlines authenticate to the health management system 104 by supplying user credentials to the health management system 104. In some examples, the health management system 104 is configured to operate as a multi-tenant system, with each airline configured as a separate tenant from the other airlines.

FIG. 2A is a block diagram of an example health management system 104. The health management system 104 includes one or more processors 202 and memory 204 storing executable instructions for the processors 202. The health management system 104 is implemented as a server system comprising one or more computers, so that the operations of the health management system 104 are distributed between the one or more computers, and so that the health management system 104 is implemented using cloud computing techniques.

The health management system includes an information collector 206. In operation, the information collector 206 collects raw data from various sources, e.g., the management information system 106, the parts management system 108, and the on-board computing systems 110a-b of FIG. 1. The health management system 104 creates, for each aircraft of the fleet of aircraft, a record for the aircraft, and then the health management system 104 populates the record with data collected by the information collector 206.

The information collector 206 receives an initial configuration for each of the aircraft. For example, the information collector 206 in one aspect receives the initial configuration from an Airframer production system. The initial configuration in one aspect specifies, e.g., a model number and a serial number for an aircraft, a model and serial number for various aircraft systems such as the engines, any optional feature information for the models, dates and places of manufacture and assembly and delivery, an Aircraft Inspection Report (AIR) including all parts of the aircraft (e.g., using part numbers and/or serial numbers), applicable documentation, logbook entries, and any appropriate information characterizing the configuration of an aircraft.

The information collector 206 then receives and stores, for each aircraft in the fleet, a history of actions altering the initial configuration of the aircraft. For example, the information collector 206 stores information characterizing upgrades to the initial configuration. The upgrades are, e.g., cabin upgrades, computer system updates, or any other appropriate kind or type of upgrade. In another example, the information collector 206 stores maintenance actions taken since the delivery date of the aircraft. The maintenance actions are in one aspect, e.g., routine maintenance actions, non-routine maintenance actions, and replacement parts installed on the aircraft.

In some examples, the information collector 206 processes the incoming raw data. For example, the information collector 206 filters the incoming raw data, e.g., to remove redundant or outdated data, and/or to correlate data between different streams of incoming data. In another example, the information collector 206 compresses, sorts, or uses any appropriate data processing technique for preparing the raw data for storage.

The health management system 104 includes a documentation producer 208. In operation, the documentation producer 208 produces, in response to a request concerning one of the aircraft, a report specifying a current configuration for the aircraft based on the initial configuration of the aircraft and the history of actions altering the initial configuration of the aircraft. The documentation producer 208 generates the report by taking the initial configuration and modifying the initial configuration to account for each of the actions altering the initial configuration of the aircraft. The report in one aspect includes, but does not have to include, the initial configuration and the history.

The health management system 104 includes a configuration checker 210. In operation, the configuration checker 210 checks the current configuration of an aircraft by determining compatibility between elements installed on the aircraft with the Air⁻framer allowed configuration including an interchangeability aspect and generating a conflict report in the event of incompatibility of a configuration. For example, an aircraft may have an upgraded suite of sensors requiring a software update to fully utilize the sensors. If the current configuration specifies that aircraft has the upgraded suite of sensors but lacks the software update, the configuration checker 210 generates a conflict report indicating that the software update should be installed to fully utilize the sensors.

The health management system 104 includes a maintenance planner 212. In operation the maintenance planner 212 generates a report or includes in a report of the documentation producer 208 one or more anticipated routine maintenance items for the aircraft based on the initial configuration of the aircraft and the history of actions altering the initial configuration of the aircraft.

For example, the anticipated routine maintenance items in one aspect are based on maintenance items required by regulatory agencies to be performed after a certain period of calendar time or flight hours or flight cycles. The maintenance planner 212 compare a most recent maintenance check from the history with the current calendar day and flight hours or flight cycles to determine when to anticipate a next maintenance check. The maintenance items are “checks” performed at regular intervals, e.g., A checks, B checks, C checks, and D checks.

Specific routine maintenance items include, e.g., cleaning aircraft and components, application of corrosion prevention compound, lubricating parts, draining and trouble shooting fuel systems, checking and servicing hydraulics and pneumatic systems, replacing components, and inspecting for general wear and tear. Routine maintenance items in one aspect are related to electronic systems on the aircraft. For example, the electronic systems include radar, instruments, computer systems, radio communications, and global positioning systems (GPSs).

The maintenance planner 212 also, in operation, generates a more general maintenance plan for an aircraft or a fleet of aircraft. For example, the maintenance planner 212 identifies a maintenance schedule for an aircraft and identifies spare parts available for the maintenance. Data specifying the spare parts availability is available from, e.g., the parts management system 108 of FIG. 1.

The maintenance planner 212 generates a task schedule including the maintenance schedule and one or more locations of spare parts available for maintenance specified by the maintenance schedule. The task schedule includes one or more non-routine maintenance tasks based on the initial configuration of the aircraft and the history of actions altering the initial configuration of the aircraft. For example, if the aircraft experienced an incident with one of the aircraft systems not operating normally or if a maintenance action is not performed as per an Airframer specification, then the maintenance planner 212 accelerates a maintenance check for that system from the normally scheduled maintenance check for that system.

The health management system 104 includes a user interface 214. The health management system 104 presents the user interface 214, e.g., by sending one or more web pages to a user device 220. The user device 220 is, e.g., a personal computer, laptop, smart phone, tablet or any other device executing a web browser that render the web pages of the user interface 214 on a display and receive user input. FIG. 2B illustrates an example screen 230 of an example user interface 214 that shows columns of a report lists for tail number 232, aircraft type-model, configuration status, and changed date. The user device 220 communicates with the health management system 104 over a data communications network, e.g., the network 112 of FIG. 1.

A user authenticates to the health management system 104 using the user interface 214 and then accesses the various services provided by the health management system 104 for that user's airline. The user interface 214 includes user interface elements for receiving requests about aircraft in a fleet, and the user interface 214 includes user interface elements for displaying reports produced by the health management system 104. In some examples, the user interface 214 includes an administration interface for a system administrator to use to perform system administration tasks on the health management system 104 itself.

FIG. 2C is a block diagram of an example configuration checker 210. The configuration checker 210 can be implemented on the health management system 104 or the management information system 106 or by both systems jointly acting together. The configuration checker 210 includes an aircraft real configuration importer 250 configured to receive an aircraft real configuration file 262 from an on-board computing system 110.

The configuration checker 210 includes an aircraft breakdown creator 256 that is configured to receive an aircraft inspection report (AIR) from a management information system 106, and the configuration checker 210 includes an aircraft certified configuration definition module 258 configured to receive service bulletins and airworthiness directives 266 from the management information system 106. The configuration checker 210 produces an aircraft certified configuration file 260, which can be archived 270 on the management information system 106. The configuration checker includes a field loadable software (FLS) exporter 254 configured to export an FLS kit file 264 to the on-board computing system 110 so as to update the aircraft with the right configuration.

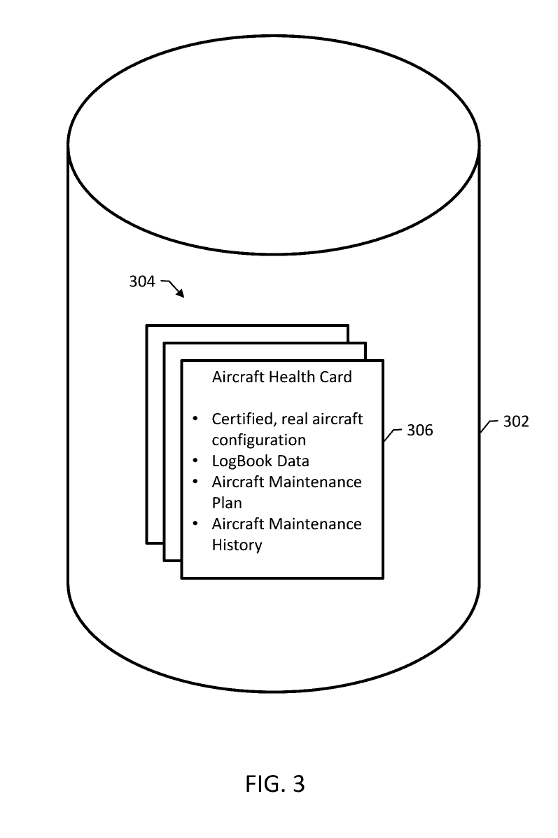

FIG. 3 is a block diagram of an example health platform database 302. The health platform database 302 is usable by the health management system 104 for storing data, e.g., data collected by the information collector 206 of FIG. 2. The health platform database 302 is implemented by a system of one or more computers, and the health platform database 302 is integrated with the health management system 104 or remote from the health management system 104.

The health platform database 302 stores records 304 called Aircraft Health Cards for a fleet of aircraft. Each record includes an initial configuration of an aircraft, e.g., on its delivery date, and a history of actions altering the initial configuration since the initial configuration. An example health card 306 stores a certified, real aircraft configuration that is current; LogBook Data; an Aircraft Maintenance Plan; and an Aircraft Maintenance History.

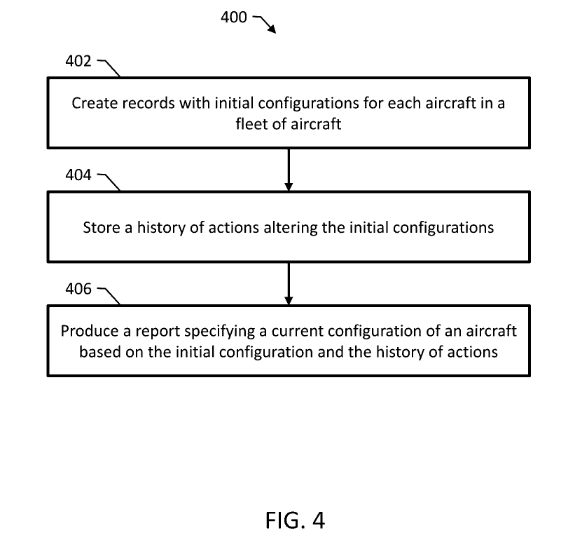

FIG. 4 is a flow diagram of an example method 400 for health management of a fleet of aircraft. The method 400 is performed by a system of one or more computers, e.g., the health management system 104 of FIGS. 1 and 2. For purposes of illustration, the method 400 will be described with respect to a system that performs the method 400.

The system creates, for each aircraft of the fleet of aircraft, a record specifying an initial configuration of the aircraft as of a delivery date of the aircraft (402). The system stores, with each record for each aircraft, a history of one or more actions altering the initial configuration of the aircraft (404). The system produces, in response to a request concerning one of the aircraft, a report specifying a current configuration for the aircraft based on the initial configuration of the aircraft and the history actions altering the initial configuration of the aircraft (406). Such a system permits to follow any modifications of an aircraft from its delivery by a manufacturer to its end life, as well as any change of ownership of the aircraft, e.g., from a leaser to operators, and to follow any operations done by a MRO (maintenance organizations) in charge of the maintenance of the aircraft.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise.

What is claimed is:

1. A system for health management of a fleet of aircraft, the system comprising:
one or more computers; and
one or more non-transitory computer readable media storing instructions that, when executed by the one or more computers, cause the one or more computers to perform operations comprising:
creating, for each aircraft of the fleet of aircraft, a record specifying an initial configuration of the aircraft as of a delivery date of the aircraft by a manufacturer;
storing, with each record for each aircraft, a history of one or more actions altering the initial configuration of the aircraft by any maintenance organization; and
producing, in response to a request concerning one of the aircraft, a report specifying a current configuration for the aircraft based on the initial configuration of the aircraft and the history of actions altering the initial configuration of the aircraft.

2. The system of claim 1, wherein storing the history for an aircraft comprises storing one or more upgrades made to the initial configuration of the aircraft.

3. The system of claim 2, wherein storing one or more upgrades comprises storing at least one cabin upgrade and at least one computer system upgrade for the aircraft.

4. The system of claim 1, wherein storing the history for an aircraft comprises storing one or more maintenance actions taken since the delivery date of the aircraft.

5. The system of claim 4, wherein storing one or more maintenance actions comprises storing one or more of: routine maintenance actions, non-routine maintenance actions, and replacement parts installed on the aircraft.

6. The system of claim 1, wherein producing the report specifying the current configuration for the aircraft comprises including in the report one or more anticipated routine maintenance items for the aircraft based on the initial configuration of the aircraft and the history of actions altering the initial configuration of the aircraft.

7. The system of claim 1, wherein producing the report specifying the current configuration for the aircraft comprises checking the current configuration by determining compatibility between each of a plurality of elements installed on the aircraft and generating a conflict report in the event of incompatibility of a configuration.

8. The system of claim 1, wherein the operations comprise planning maintenance for at least one of the aircraft of the fleet.

9. The system of claim 8, wherein planning maintenance comprises:
identifying a maintenance schedule for the aircraft;
identifying spare parts available for the maintenance as specified in a spare parts database; and
generating a task schedule comprising the maintenance schedule and one or more locations of spare parts available for the maintenance.

10. The system of claim 9, wherein generating the task schedule comprises generating one or more non-routine maintenance tasks based on the initial configuration of the aircraft and the history of actions altering the initial configuration of the aircraft.

11. A method performed by a system of one or more computers for health management of a fleet of aircraft, the method comprising:
creating, for each aircraft of the fleet of aircraft, a record specifying an initial configuration of the aircraft as of a delivery date of the aircraft by a manufacturer;
storing, with each record for each aircraft, a history of one or more actions altering the initial configuration of the aircraft by any maintenance organization; and
producing, in response to a request concerning one of the aircraft, a report specifying a current configuration for the aircraft based on the initial configuration of the aircraft and the history of actions altering the initial configuration of the aircraft.

12. The method of claim 11, wherein storing the history for an aircraft comprises storing one or more upgrades made to the initial configuration of the aircraft.

13. The method of claim 12, wherein storing one or more upgrades comprises storing at least one cabin upgrade and at least one computer system upgrade for the aircraft.

14. The method of claim 11, wherein storing the history for an aircraft comprises storing one or more maintenance actions taken since the delivery date of the aircraft.

15. The method of claim 14, wherein storing one or more maintenance actions comprises storing one or more of: routine maintenance actions, non-routine maintenance actions, and replacement parts installed on the aircraft.

16. The method of claim 11, wherein producing the report specifying the current configuration for the aircraft comprises including in the report one or more anticipated routine maintenance items for the aircraft based on the initial configuration of the aircraft and the history of actions altering the initial configuration of the aircraft.

17. The method of claim 11, wherein producing the report specifying the current configuration for the aircraft comprises checking the current configuration by determining compatibility between each of a plurality of elements installed on the aircraft and generating a conflict report in the event of incompatibility of a configuration.

18. The method of claim 11, comprising planning maintenance for at least one of the aircraft of the fleet.

19. The method of claim 18, wherein planning maintenance comprises:
identifying a maintenance schedule for the aircraft;
identifying spare parts available for the maintenance as specified in a spare parts database; and
generating a task schedule comprising the maintenance schedule and one or more locations of spare parts available for the maintenance.

20. The method of claim 19, wherein generating the task schedule comprises generating one or more non-routine maintenance tasks based on the initial configuration of the aircraft and the history of actions altering the initial configuration of the aircraft.
